(19) United States
(12) Patent Application Publication
(10) Pub. No.: US 2016/0301967 A1
(43) Pub. Date: Oct. 13, 2016

(54) Leaderboard and Advertising Distribution

(71) Applicant: Shane Venis, Edmond, OK (US)

(72) Inventor: Shane Venis, Edmond, OK (US)

(21) Appl. No.: 15/093,068

(22) Filed: Apr. 7, 2016

Related U.S. Application Data
(60) Provisional application No. 62/144,726, filed on Apr. 8, 2015.

(51) Int. Cl. H04N 21/414; H04N 21/262; A63B 71/06; H04N 21/472; H04N 21/475; H04N 21/234; H04N 21/81

(52) U.S. Cl. CPC H04N 21/41415; H04N 21/23424; H04N 21/26258; H04N 21/812; H04N 21/8126; H04N 21/47205; H04N 21/4755; H04N 21/4753; A63B 71/06

(57) ABSTRACT

A leaderboard parsing and distribution system comprises at least one computing device. The at least one computing device comprises at least one processor. The leaderboard parsing and distribution system comprises a plurality of display devices communicatively coupled to the at least one computing device. The leaderboard parsing and distribution system comprises a non-transitory machine readable medium. The non-transitory machine readable medium comprises instructions configured to cause the at least one processor to access leaderboard data. For at least two display devices in the plurality of display devices, the non-transitory machine readable medium comprises instructions configured to cause the at least one processor to select a subset of the leaderboard data to be displayed on each of the at least two display devices, and cause the subset of the leaderboard data to be displayed on the each of the at least two display devices.

### CROSS-REFERENCE TO RELATED APPLICATIONS

This application claims the benefit of U.S. Provisional Application No. 62/144,726, filed Apr. 8, 2015, which is hereby incorporated by reference in its entirety.

### BACKGROUND

At many sporting venues, leaderboard data is either printed, updated by hand, or displayed in its entirety on a single display device. At many other sporting venues, the same leaderboard data is duplicated across a plurality of display devices. At many other sporting venues, leaderboard data is segmented and displayed one segment at a time on a single display device forcing spectators interested in segments that are not currently displayed to wait for a segment of interest. Furthermore, advertising data at the many sporting venues is typically arranged on a per venue basis and is often displayed simultaneously on all display devices associated with the venue.

What is needed is the ability to parse and distribute leaderboard data and/or advertisements across a plurality of display devices configured for multiple spectator viewing.

### BRIEF DESCRIPTION OF THE SEVERAL VIEWS OF THE DRAWINGS

FIG. 1 is an example block diagram showing elements of a leaderboard parsing and distribution system as per an aspect of various embodiments.

FIG. 2 is an example block diagram showing elements of a leaderboard parsing and distribution system as per an aspect of various embodiments.

FIG. 3 illustrates an example of a plurality of display devices configured for multiple spectator viewing as per an aspect of various embodiments.

FIG. 4A is an example flow diagram of leaderboard data parsing and distribution as per aspects of various embodiments.

FIG. 4B is an example flow diagram of advertisement distribution as per aspects of various embodiments.

FIG. 5 is an example block diagram showing elements of a spectator advertising distribution system as per an aspect of various embodiments.

FIG. 6 illustrates an example of a plurality of groups of display devices configured for multiple spectator viewing as per an aspect of various embodiments.

FIG. 7A is an example flow diagram of leaderboard data parsing and distribution as per aspects of various embodiments.

FIG. 7B is an example flow diagram of advertisement parsing and distribution as per aspects of various embodiments.

FIG. 8 is a block diagram of a computing environment in which aspects of embodiments of the present invention may be practiced.

### DETAILED DESCRIPTION OF EMBODIMENTS

Various embodiments of the present invention parse and distribute data for spectator viewing.

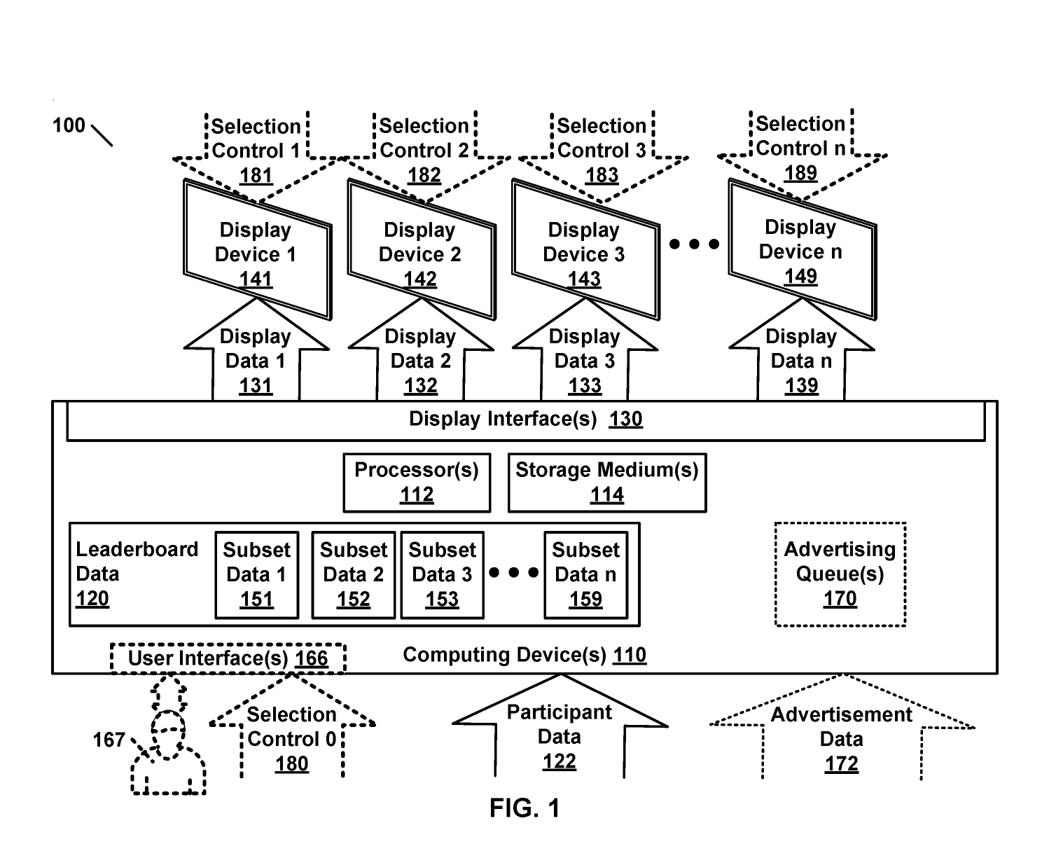

FIG. 1 is an example block diagram showing elements of a leaderboard parsing and distribution system 100 comprising at least one computing device 110. The at least one computing device 110 may comprise a personal computer, a computer server, a mobile device, a tablet, combinations thereof, and/or the like. The at least one computing device 110 may comprise at least one processor 112. The at least one processor 112 may be distributed between a plurality of computing devices.

According to some of the various embodiments, the leaderboard parsing and distribution system 100 may comprise a plurality of display devices (e.g. 141, 142, 143 . . . 149). The plurality of display devices (e.g. 141, 142, 143 . . . 149) may comprise monitors, televisions, screens configured to accept projected images, combinations thereof, and/or the like. Each of the plurality of display devices (e.g. 141, 142, 143 . . . 149) may be associated with a display identifier.

According to some of the various embodiments, display devices (e.g. 141, 142, 143 . . . 149) may be communicatively coupled to the at least one computing device 110 employing at least one display interface 130. The at least one display interface 130 may employ a display cable, a network cable, a wireless network, combinations thereof, and/or the like. Examples of the display cable may include HDMI, DVI, Display Port, combinations thereof, and/or the like. Examples of the network cable may include 10baseT, 100baseT, coaxial, fiber, combinations thereof, and/or the like. The network cable may support Ethernet, for example, configured to be at least part of a MAN, WAN, LAN, the Internet, combinations thereof, and/or the like. Examples of the wireless network may include Wi-Fi, WiMAX, LTE, Bluetooth, a TV adapter, combinations thereof, and/or the like. The TV adapter may be configured to receive streaming media from the at least one display interface 130. Examples of TV adapters may include Intel Wireless Display (WiDi), Apple AirPlay, WiGig, combinations thereof, and/or the like.

According to some of the various embodiments, the leaderboard parsing and distribution system 100 may comprise at least one non-transitory machine readable medium 114. The at least one non-transitory machine readable medium 114 may comprise instructions configured to cause the at least one processor 112 to accept participant data 122. The participant data 122 may comprise at least one name of an athlete, contestant, golfer, participant, and/or the like. The participant data 122 may further comprise associated information such as age, gender, a registration number, a team name, division, group, flight, a handicap number, a sponsor, combinations thereof, and/or the like. The participant data 122 may further comprise score information associated with each athlete, contestant, golfer, participant, and/or the like. The at least one non-transitory machine readable medium 114 may comprise instructions configured to cause the at least one processor 112 to compile at least a portion of the participant data 122 into leaderboard data 120.

According to some of the various embodiments, the leaderboard data 120 may comprise HTML data, XML data, image data, text, combinations thereof, and/or the like. For example, the leaderboard data 120 may comprise score information, progress information, name information, event information, combinations thereof, and/or the like. Score information may comprise, for example, net scores, gross scores, scores compared to par, scores per round, skin scores, exercise scores, station scores, event scores, routine scores, target scores, finish times, total times, weight, combined weight, combinations thereof, and/or the like. Progress information may comprise, for example, hole statistics, holes completed, exercises completed, stations completed, events completed, routines completed, miles completed, targets completed, shots taken, laps completed, legs completed, obstacles completed, combinations thereof, and/or the like. Name information may comprise, for example, names of golfers, athletes, teams, competitors, contestants, flights of golfers, divisions of athletes, divisions of teams, divisions of competitors, groups of contestants, numbers representing any of the aforementioned names, combinations thereof, and/or the like. Event information may comprise, for example, name(s) and or sponsor(s) of at least one event, course, tournament, competition, contest, race, combinations thereof, and/or the like.

According to some of the various embodiments, the leaderboard data 120 may be stored on the at least one non-transitory machine readable medium 114 associated with the at least one computing device 110. Alternatively, according to some of the various embodiments, the leaderboard data 120 may be stored on a remote medium, on a medium accessible over a network, on a medium accessible over the Internet, combinations thereof, and/or the like.

According to some of the various embodiments, the leaderboard data 120 may be divided into a plurality of subset data (e.g. 151, 152, 153 . . . 159). Each subset in the plurality of subset data (e.g. 151, 152, 153 . . . 159) may comprise data identifying a flight of golfers, a plurality of flights of golfers, an athlete, a plurality of athletes, a team, a plurality of teams, a competitor, a plurality of competitors, a contestant, a plurality of contestants, and/or the like. Examples of athletes may include gymnasts, triathletes, runners, biathletes, swimmers, sailors, rowers, kayakers, and/or the like. Examples of contestants may include game players, bowlers, ping pong players, pool players, poker players, gamblers, fishermen/women, shooters, combinations thereof, and/or the like. The non-transitory machine readable medium 114 may comprise instructions configured to cause the at least one processor 112 to update at least some of the subset(s) in the plurality of subset data (e.g. 151, 152, 153 . . . 159) at regular intervals. For example, regular intervals may include every minute, every 10 seconds, every time new participant data 122 is received, combinations thereof, and/or the like.

According to some of the various embodiments, the at least one non-transitory machine readable medium 114 may comprise instructions configured to cause the at least one processor 112 to send a plurality of display data (e.g. 131, 132, 133 . . . 139) to at least some of the plurality of display devices (e.g. 141, 142, 143 . . . 149) via the at least one display interface 130. At least some of the display data in the plurality of display data (e.g. 131, 132, 133 . . . 139) may comprise at least one subset data in the plurality of subset data (e.g. 151, 152, 153 . . . 159). Optionally, display data in the plurality of display data (e.g. 131, 132, 133 . . . 139) may further comprise advertisement data 172. For each display device in the plurality of display devices (e.g. 141, 142, 143 . . . 149), a specific display data in the plurality of display data (e.g. 131, 132, 133 . . . 139) may be selected for display.

According to some of the various embodiments, the leaderboard parsing and distribution system 100 may be configured to accept at least one selection control (e.g. 180, 181, 182, 183 . . . 189). The at least one selection control (e.g. 180, 181, 182, 183 . . . 189) may be accepted through at least one user interface 166. The at least one selection control (e.g. 180, 181, 182, 183 . . . 189) may be provided by at least one user 167 to select at least one display data in the plurality of display data (e.g. 131, 132, 133 . . . 139) for display device(s) in the plurality of display devices (e.g. 141, 142, 143 . . . 149). For example, selection control 0 (180) may be provided by a user of the at least one computing device 110. In this example, selection control 0 (180) may be provided to select display data in the plurality of display data (e.g. 131, 132, 133 . . . 139) for display device(s) in the plurality of display devices (e.g. 141, 142, 143 . . . 149). Alternatively, selection control(s) (e.g. 181, 182, 183 . . . 189) may be provided by at least one user of display device(s) in the plurality of display devices (e.g. 141, 142, 143 . . . 149). For example, selection control 1 (181) may be provided by a user of display device 1 (141) to select display data 1 (131) from the plurality of display data (e.g. 131, 132, 133 . . . 139).

According to some of the various embodiments, participant data 122 may be provided by a scorekeeper, a judge, a golfer, a caddy, an athlete, a competitor, a contestant, a team representative, a manager, a coach, combinations thereof, and/or the like. The at least one computing device 110 may comprise at least one user interface 166. The at least one user interface 166 may be configured to require a user login, device authentication, at least one biometric scan, combinations thereof, and/or the like to authenticate user(s) 167. At least some of the at least one computing device(s) 110 may be mobile, portable, mounted in a golf cart, mounted on a piece of fitness equipment, mounted in a broadcast booth, mounted on a boat, associated with a venue, combinations thereof, and/or the like.

According to some of the various embodiments, the at least one non-transitory machine readable medium 114 may comprise instructions causing the at least one processor 112 to cause at least one subset in the plurality of subset data (e.g. 151, 152, 153 . . . 159) on each of at least two display devices in the plurality of display devices (e.g. 141, 142, 143 . . . 149) to be displayed. Causing the at least one subset in the plurality of subset data (e.g. 151, 152, 153 . . . 159) to be displayed may comprise communicating with at least two display devices employing at least one display interface 130. For example, leaderboard data 120 may comprise data relating to a plurality of flights in a golf tournament. In this example, at least one subset data in the plurality of subset data (e.g. 151, 152, 153 . . . 159) may relate to a group of flights. The group of flights may be smaller in number than the plurality of flights. In this example, data relating to each group of flights may be transmitted to a specific display device in the at least two display devices configured to display the leaderboard data to spectators present at the tournament. As another example, the leaderboard data may comprise data relating to a plurality of athletes participating in a triathlon competition. In this example, each of the at least one subset data in the plurality of subset data (e.g. 151, 152, 153 . . . 159) may relate to a group of athletes in a specific division. The group of athletes may be smaller in number than the plurality of athletes. In this example, data relating to each division of athletes may be transmitted to a specific display device in the at least two display devices configured to display the leaderboard data to spectators present at the competition.

According to some of the various embodiments, advertisement data 172 may be provided to the at least one computing device 110. The at least one computing device 110 may comprise at least one advertising queue 170. The at least one advertising queue 170 may be configured to store the advertisement data 172. The leaderboard parsing and distribution system 100 may be further configured to add at least a portion of the advertisement data 172 from the at least one advertising queue 170 to display data in the plurality of display data (e.g. 131, 132, 133 . . . 139).

According to some of the various embodiments, the at least one non-transitory machine readable medium 114 may comprise instructions causing the at least one processor 112 to access at least one advertisement in the advertisement data 172. The at least one non-transitory machine readable medium 114 may comprise instructions causing the at least one processor 112 to select at least one display device in the plurality of display devices (e.g. 141, 142, 143 . . . 149) and cause the at least one advertisement to be displayed on the at least one display device (e.g. 141, 142, 143 . . . 149).

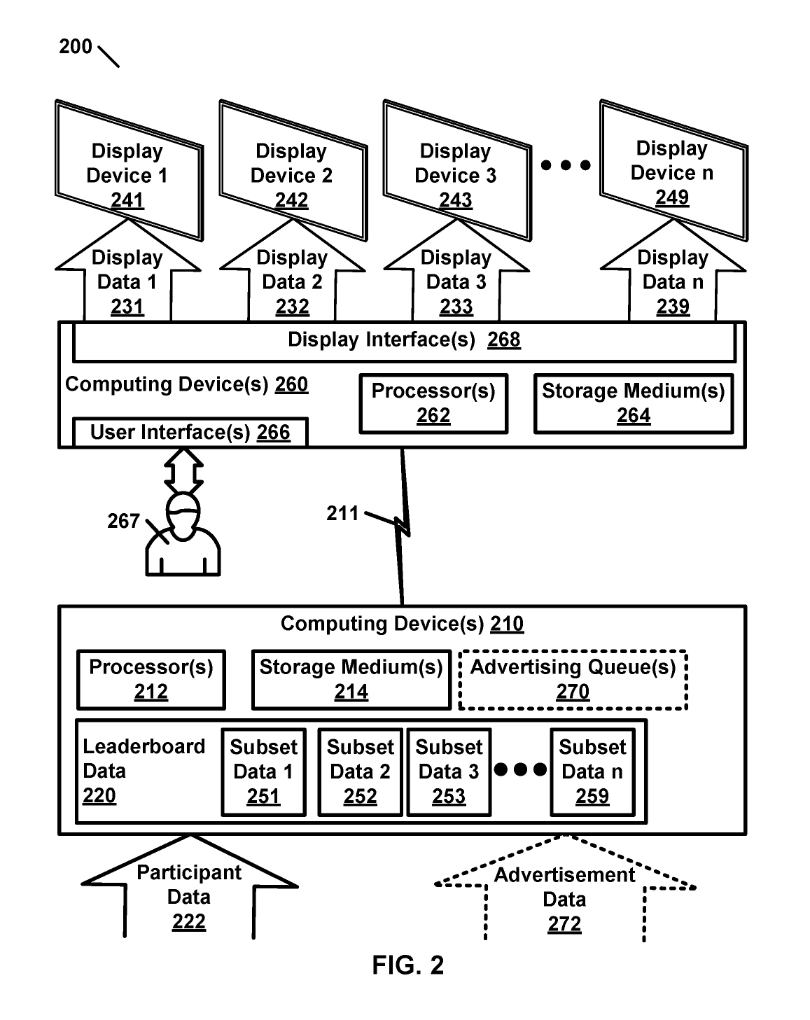

FIG. 2 is an example block diagram showing elements of a leaderboard parsing and distribution system 200 comprising at least one computing device 210 and at least one computing device 260. The at least one computing device 210 may comprise at least one processor 212. According to some of the various embodiments, processor(s) from among the at least one processor 212 may be distributed between a plurality of computing device(s) 210. The at least one computing device 210 may comprise at least one computer server. Similarly, the at least one computing device 260 may comprise at least one processor 262. According to some of the various embodiments, processor(s) from among the at least one processor 262 may be distributed between a plurality of computing device(s) 260. The at least one computing device 260 may comprise at least one client device. The at least one client device may comprise a personal computer, a mobile device, a tablet, combinations thereof, and/or the like. At least some of the at least one computing device 210 and some of the at least one computing device 260 may be communicatively coupled by at least one network connection 211. At least part of the at least one network connection 211 may be part of a network.

According to some of the various embodiments, the leaderboard parsing and distribution system 200 may comprise at least one non-transitory machine readable medium 214. The at least one non-transitory machine readable medium 214 may comprise instructions configured to cause the at least one processor 212 to accept participant data 222. The at least one non-transitory machine readable medium 214 may comprise instructions configured to cause the at least one processor 212 to compile at least a portion of the participant data 222 into leaderboard data 220. The leaderboard data 220 may be stored on the at least one non-transitory machine readable medium 214 associated with the at least one computing device 210. Alternatively, the leaderboard data 220 may be stored on a remote medium, on a medium accessible over a network, on a medium accessible over the Internet, combinations thereof, and/or the like. The leaderboard data 220 may be divided into a plurality of subset data (e.g. 251, 252, 253 . . . 259).

According to some of the various embodiments, the at least one non-transitory machine readable medium 214 may comprise instructions configured to cause the at least one processor 212 to send at least some of the plurality of subset data (e.g. 251, 252, 253 . . . 259) to the at least one computing device 260 employing network connection 211. The at least one computing device 210 may comprise at least one advertising queue 270. The at least one advertising queue 270 may be configured to store advertisement data 272. The at least one non-transitory machine readable medium 214 may comprise instructions configured to cause the at least one processor 212 to send at least a portion of the advertisement data 272 to the at least one computing device 260 employing network connection 211.

According to some of the various embodiments, the leaderboard parsing and distribution system 200 may comprise a plurality of display devices (e.g. 241, 242, 243 . . . 249). The plurality of display devices (e.g. 241, 242, 243 . . . 249) may be communicatively coupled to the at least one computing device 260 employing at least one display interface 268.

According to some of the various embodiments, at least one of the plurality of display devices (e.g. 241, 242, 243 . . . 249) may comprise a touch screen. The touch screen may be configured to enable input by a golfer, a caddy, an athlete, a competitor, a contestant, a team representative, a manager, a coach, a spectator, combinations thereof, and or the like. As an example, a golfer or caddy may input login information associated with an account, registration information associated with a tournament, score confirmation, combinations thereof, and/or the like. A manager may, for example, be a manager of: a golfer, an athlete, a competitor, a contestant, a venue, combinations thereof, and/or the like. As another example, a spectator may input login information associated with an account, at least one preference associated with the touch screen, at least one preference associated with the leaderboard data, selection of at least one advertisement, selection of at least one HTML link, combinations thereof, and/or the like.

According to some of the various embodiments, the at least one non-transitory machine readable medium 264 may comprise instructions configured to cause the at least one processor 262 to send a plurality of display data (e.g. 231, 232, 233 . . . 239) to at least one of the plurality of display devices (e.g. 241, 242, 243 . . . 249) via at least one display interface 268. Each display data in the plurality of display data (e.g. 231, 232, 233 . . . 239) may comprise at least one subset data in the plurality of subset data (e.g. 251, 252, 253 . . . 259). At least one display data in the plurality of display data (e.g. 231, 232, 233 . . . 239) may further comprise the advertisement data 272. For display device(s) in the plurality of display devices (e.g. 241, 242, 243 . . . 249), a specific display data in the plurality of display data (e.g. 231, 232, 233 . . . 239) may be selected for display.

Some of the various embodiments may include a user interface 266. The user interface 266 may be configured to enable a user 267 to select at least one subset data in the plurality of subset data (e.g. 251, 252, 253 . . . 259). The user interface 266 may be further configured to enable the user to direct at least one subset data in the plurality of subset data (e.g. 251, 252, 253 . . . 259) to a specific display device in the plurality of display devices (e.g. 241, 242, 243 . . . 249).

According to some of the various embodiments, the leaderboard parsing and distribution system 200 may be configured to accept registrations for a tournament, a sporting event, a competition, a contest, a race, combinations thereof, and/or the like. For example, Golfers may register for a tournament, event, and/or round of golf using a Golf Handicap and Information Network (GHIN) Number. Alternatively, golfers may register using biometric data via, for example, at least one biometric scan.

According to some of the various embodiments, at least some of the plurality of display data (e.g. 231, 232, 233 . . . 239) may be displayed simultaneously with video streamed from at least one location in a venue. Display data (e.g. 231, 232, 233 . . . 239) may be superimposed over the video, presented in a split screen format with the video, presented in a picture-in-picture arrangement, combinations thereof, and/or the like. Likewise, display data (e.g. 231, 232, 233 . . . 239) may be displayed while audio is streamed from at least one location in the venue. For example, the video and/or audio may originate at a hole on a golf course, at a finish line of a race, in a transition area of a triathlon, in an area configured for at least one announcer, in proximity of a piece of gymnastic equipment, in proximity of a piece of gaming equipment, in proximity of a game console, in proximity of a game table, in view of a target, in view of a timing pad, on a boat, in proximity of an end of a lane, combinations thereof, and/or the like.

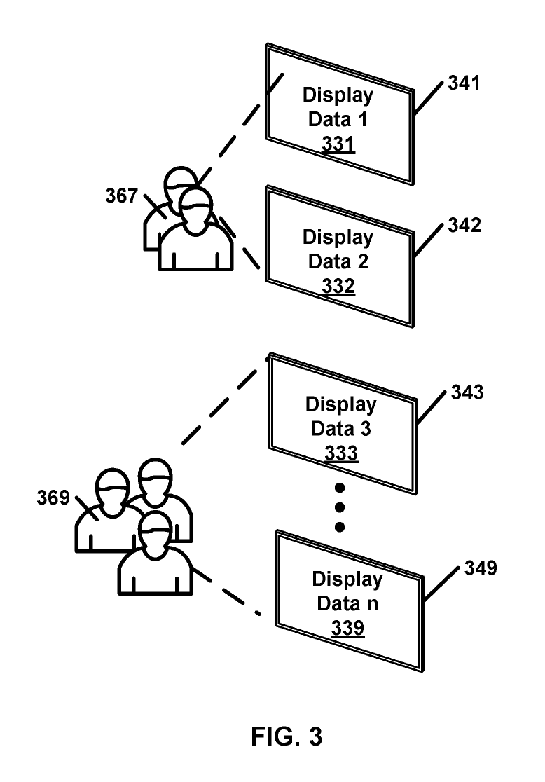

FIG. 3 illustrates an example of a plurality of display devices (e.g. 341, 342, 343 . . . 349) configured for multiple spectator (e.g. 367, 369) viewing as per an aspect of various embodiments. Each display device in the plurality of display devices (e.g. 341, 342, 343 . . . 349) may be configured to present display data (e.g. 331, 332, 333 . . . 339). At least two display devices in the plurality of display devices (e.g. 341, 342, 343 . . . 349) may be configured for multiple spectator (e.g. 367, 369) viewing. For example, the at least two display devices (e.g. 341, 342) may be mounted at a height to enable viewing by spectators 367 such as, for example, standing spectators, seated spectators, walking spectators, combinations thereof, and/or the like. In this example, each of the at least two display devices (e.g. 341, 342) may be mounted adjacent to open space large enough to support a plurality of spectators 367. The plurality of spectators 367 may be enabled to choose at least one display device of interest to view.

According to some of the various embodiments, display(s) within the plurality of display devices (e.g. 341, 342, 343 . . . 349) may be configured for landscape orientation and/or portrait orientation. The plurality of display devices (e.g. 341, 342, 343 . . . 349) may be associated with a venue. At least one display device in the plurality of display devices (e.g. 341, 342, 343 . . . 349) may comprise a distinct location within the venue. For example, the plurality of display devices (e.g. 341, 342, 343 . . . 349) may be associated with a golf course. In this example, the at least one display device (e.g. 341, 342) may be located in a club house, in at least one restaurant, in at least one bar, combinations thereof, and/or the like. In this example, at least one additional display device (e.g. 343 . . . 349) may be distributed around an outdoor viewing area.

According to some of the various embodiments, at least one display device in the plurality of display devices (e.g. 341, 342, 343 . . . 349) may be configured to be portable. A portable display device may comprise, for example, a cart comprising at least two wheels and configured to support the at least one display device at a height configured for multiple spectator viewing. The portable display device may be further configured to be packable in a case configured for transportation and/or storage.

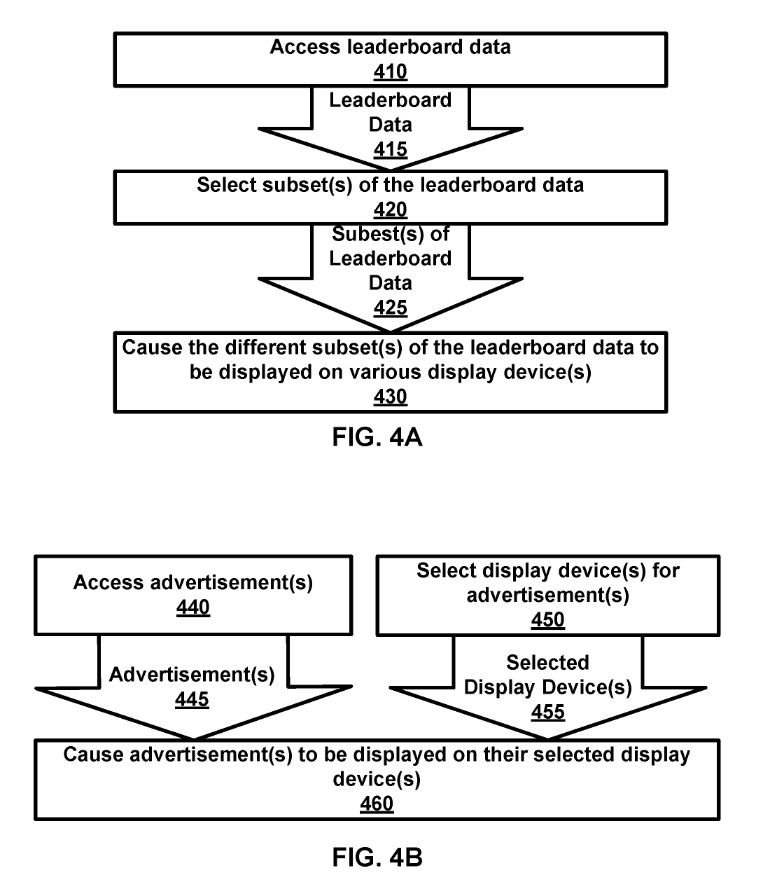

FIG. 4A is an example flow diagram of leaderboard data parsing and distribution as per aspects of various embodiments. At 410, access to leaderboard data 415 may be enabled. At 420, selection of at least one subset of the leaderboard data 425 may be enabled. At 430, instructions may cause the different subsets of the leaderboard data to be displayed on various display devices.

FIG. 4B is an example flow diagram of advertisement distribution as per aspects of various embodiments. At 440, access to at least one advertisement 445 may be enabled. At 450, at least one display device 455 may be selected for the at least one advertisement. At 460, instructions may cause the at least one advertisement 445 to be displayed on the at least one selected display device 455 associated with the at least one identifier.

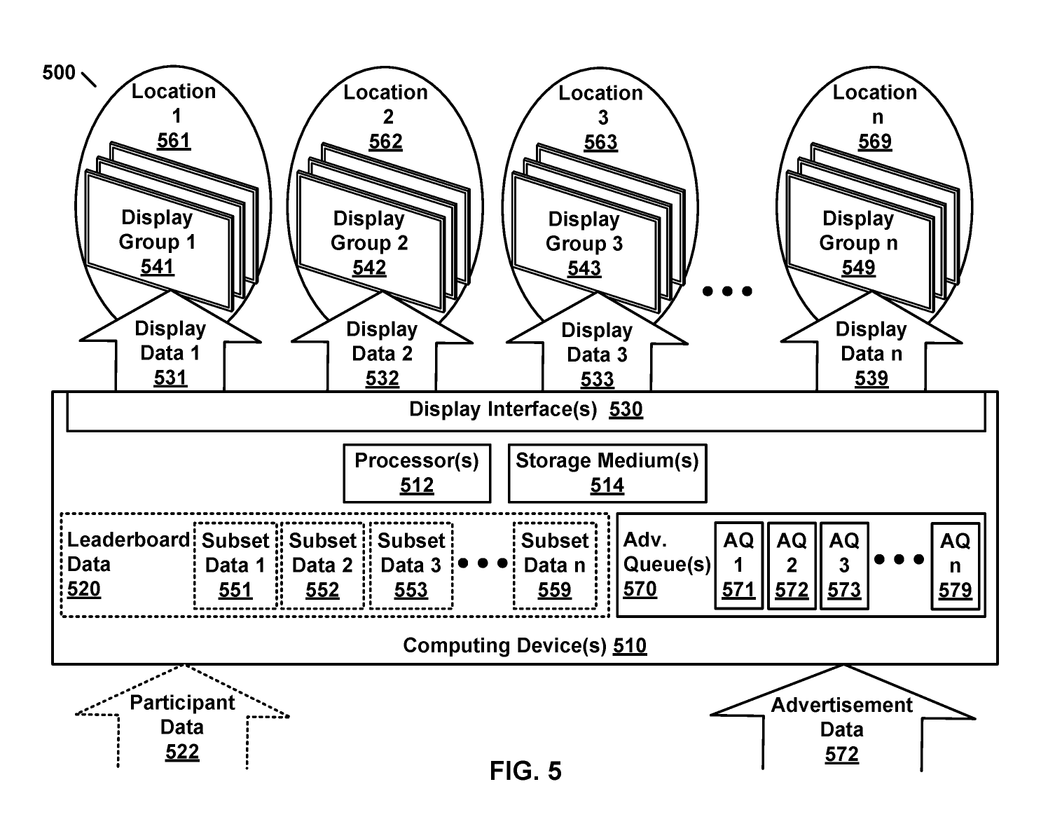

FIG. 5 is an example block diagram showing elements of a spectator advertising distribution system 500 comprising at least one computing device 510. The at least one computing device 510 may comprise at least one processor 512. The at least one processor 512 may be distributed between a plurality of computing device(s) 510. The spectator advertising distribution system 500 may comprise at least one non-transitory machine readable medium 514. The at least one non-transitory machine readable medium 514 may comprise instructions configured to cause the at least one processor 512 to accept advertisement data 572. The advertisement data 572 may comprise a plurality of advertisements. The at least one non-transitory machine readable medium 514 may further comprise instructions configured to cause the at least one processor 512 to select at least one advertisement from the plurality of advertisements. Alternatively, the at least one non-transitory machine readable medium 514 may comprise instructions configured to cause the at least one processor 512 to accept selection of the at least one advertisement from a user of the computing device(s) 510 or a user of a remote computing device communicatively coupled to the computing device(s) 510. The computing device(s) 510 may be configured to enable the selection of the at least one advertisement from a remote server configured to accept download requests by the at least one computing device 510 for the plurality of advertisements.

According to some of the various embodiments, the at least one non-transitory machine readable medium 514 may comprise instructions configured to cause the at least one processor 512 to accept participant data 522. The at least one non-transitory machine readable medium 514 may comprise instructions configured to cause the at least one processor 512 to compile at least a portion of the participant data 522 into leaderboard data 520. The leaderboard data 520 may be stored on the at least one non-transitory machine readable medium 514 associated with the at least one computing device 510. Alternatively, the leaderboard data 520 may be stored on a remote medium, on a medium accessible over a network, on a medium accessible over the Internet, combinations thereof, and/or the like. The leaderboard data 520 may be divided into a plurality of subset data (e.g. 551, 552, 553 . . . 559).

According to some of the various embodiments, the spectator advertising distribution system 500 may comprise a plurality of groups of display devices (e.g. 541, 542, 543 . . . 549). The plurality of groups of display devices (e.g. 541, 542, 543 . . . 549) may comprise monitors, televisions, screens configured to accept projected images, combinations thereof, and/or the like. Each group of display devices in the plurality of groups of display devices (e.g. 541, 542, 543 . . . 549) may be associated with a group identifier.

Each display device in the plurality of groups of display devices (e.g. 541, 542, 543 . . . 549) may be communicatively coupled to the at least one computing device 510 employing at least one display interface 530. The at least one display interface 530 may be configured to support a set of streaming connections associated with at least one group of display devices in the plurality of groups of display devices (e.g. 541, 542, 543 . . . 549). The spectator advertising distribution system 500 may further comprise a plurality of locations (e.g. 561, 562, 563 . . . 569). Each location in the plurality of locations (e.g. 561, 562, 563 . . . 569) may be associated with a group of display devices in the plurality of groups of display devices (e.g. 541, 542, 543 . . . 549). Each location in the plurality of locations (e.g. 561, 562, 563 . . . 569) may be associated with a distinct venue. The plurality of groups of display devices (e.g. 541, 542, 543 . . . 549) and/or the plurality of locations (e.g. 561, 562, 563 . . . 569) may be associated with a single owner, ownership group, business, combinations thereof, and/or the like.

According to some of the various embodiments, the at least one non-transitory machine readable medium 514 may comprise instructions configured to send a plurality of group display data (e.g. 531, 532, 533 . . . 539) to at least some of the plurality of groups of display devices (e.g. 541, 542, 543 . . . 549) via the at least one display interface 530. The spectator advertising distribution system 500 may comprise at least one advertising queue 570. The at least one advertising queue 570 may be configured to store at least a portion of the advertisement data 572. The at least one advertising queue 570 may be subdivided into a plurality of specific advertising queues (e.g. 571, 572, 573 . . . 579). Specific advertising queue(s) in the plurality of specific advertising queues (e.g. 571, 572, 573 . . . 579) may be associated with a specific group display data in the plurality of group display data (e.g. 531, 532, 533 . . . 539). Each group display data in the plurality of group display data (e.g. 531, 532, 533 . . . 539) may comprise a plurality of display data. Each display data in the plurality of display data may be selected for display on at least one display device in the corresponding group of display devices.

According to some of the various embodiments, the at least one non-transitory machine readable medium 514 may comprise instructions configured to cause the at least one processor 512 to select at least one group of display devices in the plurality of groups of display devices (e.g. 541, 542, 543 . . . 549). The instructions may further comprise adding the at least one advertisement to at least one specific advertising queue in the plurality of specific advertising queues (e.g. 571, 572, 573 . . . 579). The spectator advertising distribution system 500 may further comprise a user interface configured to enable a user to select the at least one advertisement from the advertisement data 572 and the at least one group of display devices from the plurality of groups of display devices (e.g. 541, 542, 543 . . . 549). The user interface may be configured to enable a user to select the at least one advertisement from the advertisement data 572 and at least one specific advertising queue in the plurality of specific advertising queues (e.g. 571, 572, 573 . . . 579).

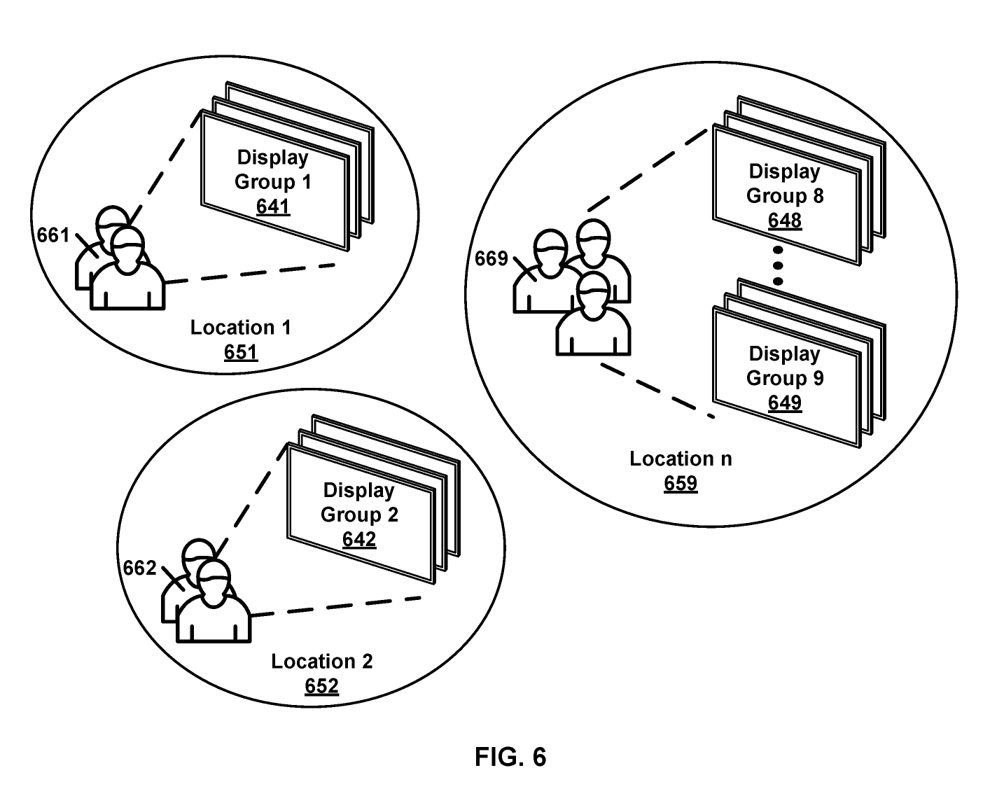

FIG. 6 illustrates an example of a plurality of locations (e.g. 651, 652, 659). Each location may comprise at least one group of display devices (e.g. 641, 642, 648 . . . 649). Each location in the plurality of locations (e.g. 651, 652, 659) may be configured to support multiple spectator viewing (e.g. 661, 662, 669) for at least one display device in at least one group of display devices (e.g. 641, 642, 648 . . . 649). Each location in the plurality of locations (e.g. 651, 652, 659) may be associated with a distinct venue. For example, each location may be associated with a distinct golf course in a plurality of golf courses. In this example, the at least one display device in each of the at least one group of display devices may be configured for multiple spectator viewing of a golf tournament. The at least one display device may be mounted at a height to enable viewing by standing spectators, seated spectators, walking spectators, combinations thereof, and/or the like. Display device(s) may be mounted adjacent to open space large enough to support a plurality of spectators. Some of the display device(s) in each of the at least one group of display devices (e.g. 641, 642, 648 . . . 649) may be configured for landscape orientation and/or portrait orientation.

According to some of the various embodiments, at least one display device in some of the at least one group of display devices (e.g. 641, 642, 648 . . . 649) may be configured to be portable. A portable display device may comprise, for example, a cart comprising at least two wheels and configured to support the at least one display device at a height configured for multiple spectator viewing. The portable display device may be further configured to be packable in a case configured for transportation and/or storage. Some of the display device(s) in the at least one group of display devices (e.g. 641, 642, 648 . . . 649) may comprise a touch screen.

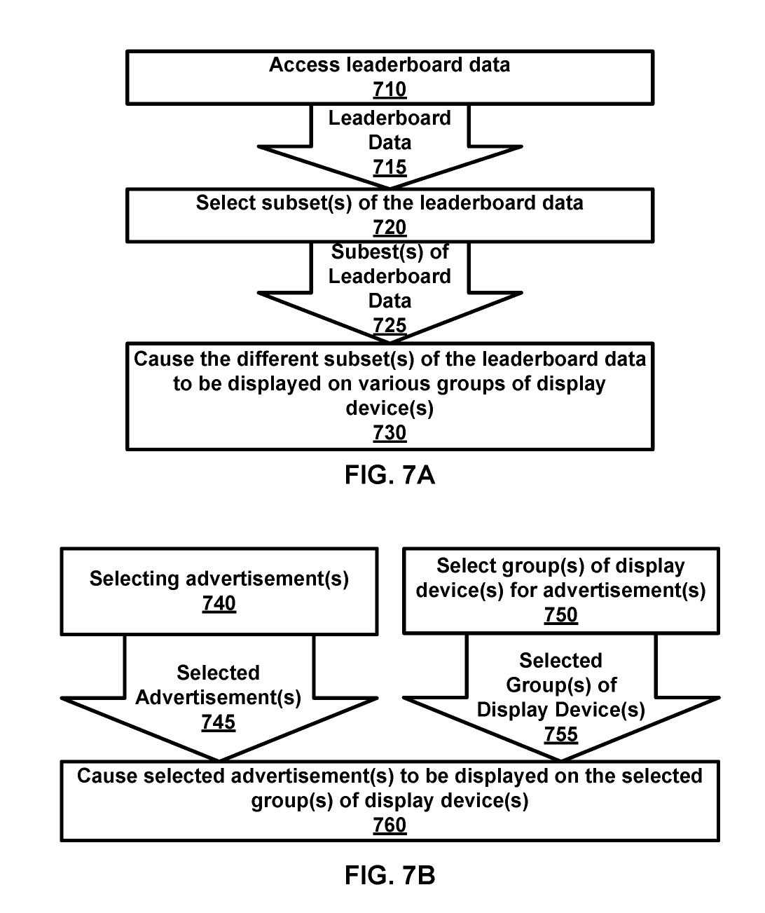

FIG. 7A is an example flow diagram of leaderboard data parsing and distribution as per aspects of various embodiments. At 710, access to leaderboard data 715 may be enabled. At 720, selection of at least one subset of the leaderboard data 725 may be enabled. At 730, instructions may be configured to cause the different subsets of the leaderboard data 725 to be displayed on various groups of display devices.

FIG. 7B is an example flow diagram of advertisement parsing and distribution as per aspects of various embodiments. At 740, at least one advertisement 745 may be selected. At step 750, group(s) of display device(s) 755 for at least one advertisement may be selected. The selected group(s) of display device(s) 755 may be identified by at least one group identifier associated with each of the selected group(s) of display device(s). At 760, instructions may be configured to cause the at least one selected advertisement 745 to be displayed on the at least one selected group(s) of display device(s) 755 associated with the at least one group identifier.

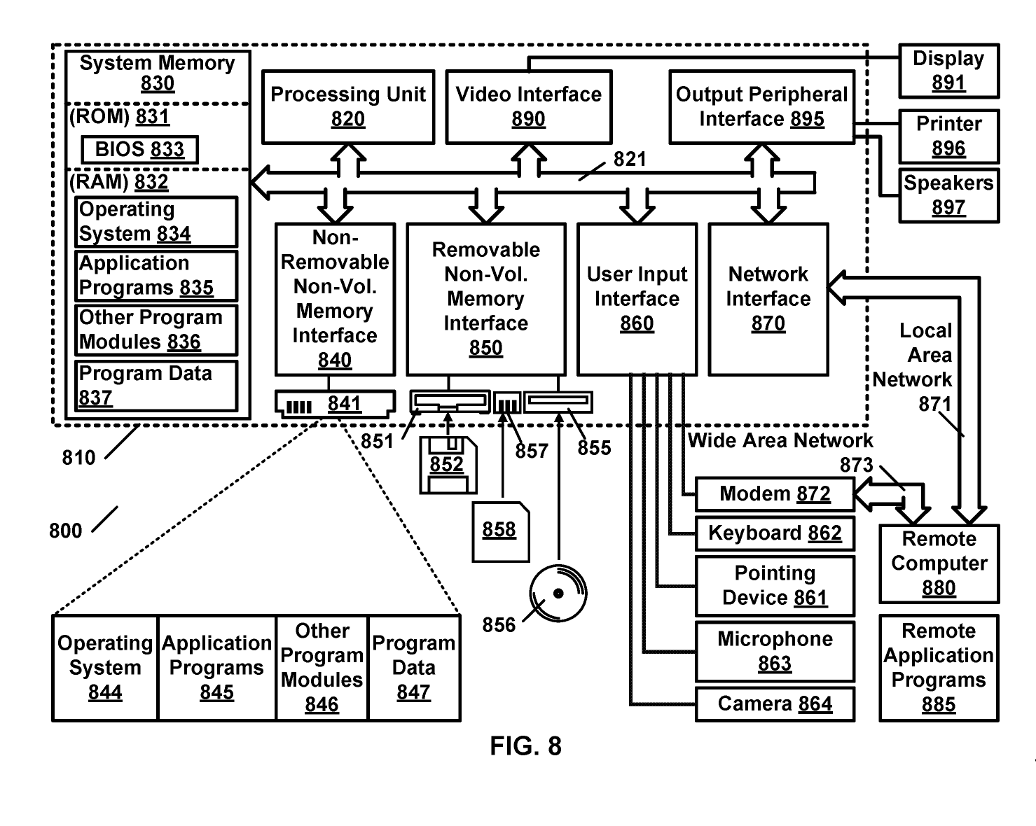

FIG. 8 illustrates an example system for implementing at least some embodiments and comprises a general-purpose computing device in the form of a computing device 810. Components of computing device 810 may include, but are not limited to, a processing unit 820, a system memory 830, and a system bus 881 that couples various system components including the system memory to the processing unit 820.

Computing device 810 typically includes a variety of computer readable media. Computer readable media can be any available media that can be accessed by computing device 810 and may include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer readable media.

The system memory 830 includes computer storage media in the form of volatile and/or nonvolatile memory such as ROM 831 and RAM 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computing device 810 may also include other removable/non-removable volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, a flash drive reader 857 that reads flash drive 858, and an optical disk drive 855 that reads from or writes to a removable, nonvolatile optical disk 856 such as a CD ROM or other optical media. Other removable/non-removable, volatile/nonvolatile computer storage media that may be used in the operating environment include, but are not limited to, magnetic tape cassettes, flash memory cards, digital versatile disks, digital video tape, solid state RAM, solid state ROM, and the like. The hard disk drive 841 is typically connected to the system bus 881 through a non-removable memory interface such as interface 840, and magnetic disk drive 851 and optical disk drive 855 are typically connected to the system bus 881 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, program data 847, and other program modules 846. Additionally, for example, non-volatile memory may include instructions for presenting and updating personal information on a display 891 of computing device 800 and/or the like. Similarly, non-volatile memory may include instructions for causing the presentation of personal information on the display of a remote computing device 880 and/or the like.

A user may enter commands and information into computing device 810 through input devices such as a keyboard 868, a microphone 863, a camera 864, and a pointing device 861, such as a mouse, trackball or touch pad. These and other input devices are often connected to the processing unit 820 through a user input interface 860 that is coupled to the system bus, but may be connected by other interface and bus structures, such as a parallel port, game port or a universal serial bus (USB). A display 891 or other type of display device may also be connected to the system bus 881 via an interface, such as a video interface 890. Other devices, such as, for example, speakers 897 and printer 896 may be connected to the system via peripheral interface 895.

The computing device 810 may be operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computing device 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computing device 810 is connected to the LAN 871 through a network interface or adapter 870. When used in a WAN networking environment, the computing device 810 typically includes a modem 872 or other means for establishing communications over the WAN 873, such as the Internet. The modem 872, which may be internal or external, may be connected to the system bus 881 via the user input interface 860, or other appropriate mechanism. The modem 872 may be wired or wireless. Examples of wireless devices may comprise, but are not limited to: Wi-Fi and Bluetooth. In a networked environment, program modules depicted relative to the computing device 810, or portions thereof, may be stored in the remote memory storage device. By way of example, and not limitation, FIG. 8 illustrates remote application programs 885 as residing on remote computer 880. It will be appreciated that the network connections shown are presented as examples only and other means of establishing a communications link between the computers may be used.

Although the subject matter has been described in language specific to system features and/or instructions, it is to be understood that the subject matter defined in the appended claims is not necessarily limited to the specific features or instructions described above. Rather, the specific features and instructions described above are disclosed as example forms of implementing the claims.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element) or a combination thereof, all of which are behaviorally equivalent. For example, modules may be implemented using computer hardware in combination with software routine(s) written in a computer language (Java, HTML, XML, PHP, Python, ActionScript, JavaScript, Ruby, Prolog, SQL, VBScript, Visual Basic, Perl, C, C++, Objective-C or the like). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, flash memory, memory cards, electrically erasable programmable read-only memory (EEPROM), solid state drives, optical disks, barcodes, magnetic ink characters, and/or the like.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, systems have been described as including at least one computing device. However, one skilled in the art will recognize that the at least one computing device may comprise a server and client device. The server and client device may vary from a traditional server/device relationship over a network such as the internet. For example, a server may be collective based: portable equipment, broadcast equipment, virtual, application(s) distributed over a broad combination of computing sources, part of a cloud, and/or the like. Similarly, for example, a client device may be a user based client, portable equipment, broadcast equipment, virtual, application(s) distributed over a broad combination of computing sources, part of a cloud, and/or the like. Additionally, it should be noted that, for example purposes, several of the various embodiments were described as processes. However, one skilled in the art will recognize that many various languages and frameworks may be employed to build and use embodiments of the present invention. For example, languages/frameworks may be based upon Java, HTML, XML, PHP, Python, ActionScript, JavaScript, Ruby, Prolog, SQL, VBScript, Visual Basic, Perl, C, C++, Objective-C combinations thereof, and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A leaderboard parsing and distribution system comprising:
a. at least one computing device comprising at least one processor;
b. a plurality of display devices communicatively coupled to the at least one computing device; and
c. a non-transitory machine readable medium comprising instructions configured to cause the at least one processor to:
i. access leaderboard data; and
ii. for at least two display devices in the plurality of display devices:
1. select a subset of the leaderboard data to be displayed on each of the at least two display devices; and
2. cause the subset of the leaderboard data to be displayed on the each of the at least two display devices.

2. The leaderboard parsing and distribution system according to claim 1, wherein the at least one computing device comprises at least one of the following:
a. a personal computer;
b. a computer server;
c. a mobile device; and
d. a tablet.

3. The leaderboard parsing and distribution system according to claim 1, wherein at least two of the plurality of display devices are configured for multiple spectator viewing.

4. The leaderboard parsing and distribution system according to claim 1, wherein at least one display device in the plurality of display devices is configured to be portable.

5. The leaderboard parsing and distribution system according to claim 1, wherein the leaderboard data comprises at least one of the following:
a. HTML data;
b. XML data;
c. image data; and
d. text.

6. The leaderboard parsing and distribution system according to claim 1, wherein the subset of the leaderboard data comprises data identifying at least one of the following:
a. a flight of golfers;
b. a plurality of flights of golfers;
c. an athlete;
d. a plurality of athletes;
e. a team;
f. a plurality of teams;
g. a competitor;
h. a plurality of competitors;
i. a contestant; and
j. a plurality of contestants.

7. The leaderboard parsing and distribution system according to claim 1, wherein the machine readable medium further comprises instructions configured to cause the at least one processor to update the subset of the leaderboard data at regular intervals.

8. The leaderboard parsing and distribution system according to claim 1, further comprising a user interface and wherein the machine readable medium further comprises instructions configured to cause the at least one processor to enable a user via the user interface to select the subset of the leaderboard data and direct the subset to a specific display device in the plurality of display devices.

9. The leaderboard parsing and distribution system according to claim 1, wherein the machine readable medium further comprises instructions configured to cause the at least one processor to accept registrations for at least one of the following;
a. a tournament;
b. a sporting event;
c. a competition; and
d. a contest.

10. The leaderboard parsing and distribution system according to claim 1, wherein at least one of the plurality of display devices is a touch screen configured to enable input by at least one of the following:
a. a golfer;
b. a caddy;
c. an athlete;
d. a competitor;
e. a contestant;
f. a team representative;
g. a manager;
h. a coach; and
i. a spectator.

11. The leaderboard parsing and distribution system according to claim 1, wherein the machine readable medium further comprises instructions configured to cause the at least one processor to:
a. access at least one advertisement;
b. select at least one display device in the plurality of display devices; and
c. cause the at least one advertisement to be displayed on the at least one display device.

12. The leaderboard parsing and distribution system according to claim 11, further comprising a user interface and wherein the machine readable medium further comprises instructions configured to cause the at least one processor to enable a user via the user interface to select the at least one display device.

13. A spectator advertising distribution system comprising:
a. at least one computing device comprising at least one processor;
b. a plurality of groups of display devices communicatively coupled to the at least one computing device, each group in the plurality of groups of display devices associated with a distinct venue; and
c. a non-transitory machine readable medium comprising instructions configured to cause the at least one processor to:
i. select at least one advertisement from a plurality of advertisements;
ii. select at least one group of display devices in the plurality of groups of display devices; and
iii. add the at least one advertisement to an advertising queue associated with the at least one group of display devices.

14. The spectator advertising distribution system according to claim 13, wherein the at least one computing device comprises at least one of the following:
a. a personal computer;
b. a computer server;
c. a mobile device; and
d. a tablet.

15. The spectator advertising distribution system according to claim 13, wherein the plurality of groups of display devices are configured for multiple spectator viewing.

16. The spectator advertising distribution system according to claim 13, wherein the at least one group of display devices in the plurality of groups of display devices comprises at least one display device configured to be portable.

17. The spectator advertising distribution system according to claim 13, wherein the at least one group of display devices in the plurality of groups of display devices comprises at least one touch screen configured to enable input by at least one of the following:
a. a golfer;
b. a caddy;
c. an athlete;
d. a competitor;
e. a contestant;
f. a team representative;
g. a manager; and
h. a coach.

18. The spectator advertising distribution system according to claim 13 wherein the distinct venue comprises at least one of the following:
a. a golf course;
b. a stadium;
c. a gymnasium;
d. at least one outdoor spectating area;
e. at least one indoor spectating area;
f. at least one transition area;
g. a club house;
h. at least one shooting area;
i. at least one body of water; and
j. at least one fishing area.

19. The spectator advertising distribution system according to claim 13, wherein the advertising queue is configured to store the at least one advertisement for addition to a set of streaming connections associated with the at least one group of display devices.

20. The spectator advertising distribution system according to claim 13, further comprising a user interface and wherein the machine readable medium further comprises instructions configured to cause the at least one processor to enable a user via the user interface to select the at least one advertisement and the at least one group of display devices.
